(19) United States
(12) Patent Application Publication
(10) Pub. No.: US 2020/0159029 A1
(43) Pub. Date: May 21, 2020

(54) OPTICAL TRANSMISSION HINGE

(71) Applicant: North Inc., Kitchener (CA)

(72) Inventor: Daniel Robert Adema, Kitchener (CA)

(21) Appl. No.: 16/688,458

(22) Filed: Nov. 19, 2019

Related U.S. Application Data
(60) Provisional application No. 62/770,561, filed on Nov. 21, 2018.

(51) Int. Cl. G02B 27/01; G02C 5/22; G02B 6/36

(52) U.S. Cl. CPC G02B 27/0176; G02B 6/3604; G02C 5/22

(57) ABSTRACT

An optical transmission hinge includes a first hinge body and a second hinge body. A pivot joint is formed between the first hinge body and the second hinge body. The pivot joint defines a pivot axis. A first optical element and a second optical element are positioned on the pivot axis, and the second optical element is spaced apart from the first optical element. An intermediary optical path that is coincident with the pivot axis extends between the first optical element and the second optical element. Temples and wearable heads-up displays including the optical transmission hinge are disclosed.

### CROSS-REFERENCE TO RELATED APPLICATIONS

This application claims the benefit of U.S. Provisional Application No. 62/770561, filed 21 Nov. 2018, titled “Optical Transmission Hinge”, the content of which is incorporated herein in its entirety by reference.

### TECHNICAL FIELD

The disclosure generally relates to structures that enable folding of eyewear into a compact form and more particularly to structures that enable folding of a support structure carrying display components into a compact form.

### BACKGROUND

Wearable heads-up displays (WHUDs) are optical systems that can be worn on the head and that enable users to see content in a display space without preventing the users from seeing their environment. There is a class of WHUDs having the appearance of eyeglasses. These WHUDs have a support structure including a frame front and two temples attached to opposite sides of the frame front in a manner similar to traditional eyeglasses. In traditional eyeglasses, hinges between temples and the frame front enable folding of the temples inward for compact storage of the eyeglasses. In WHUDs, hinges may be located between the frame front and temples or somewhere on the temples to enable folding of the temples when the WHUD is not in use. Unlike traditional eyeglasses, the temple(s) and frame front of WHUDs typically carry display components that need to communicate optically. In some cases, it may be desired to locate a hinge between display components that need to communicate optically. However, maintaining optical alignment accuracy across a hinge that is located in an optical path has been challenging.

### SUMMARY

In a first aspect of this disclosure, an optical transmission hinge may be summarized as including a first hinge body; a second hinge body; a pivot joint formed between the first hinge body and the second hinge body, the pivot joint defining a pivot axis; a first optical element positioned on the pivot axis and coupled to the first hinge body; a second optical element positioned on the pivot axis and coupled to the second hinge body, the second optical element spaced apart from the first optical element; and an intermediary optical path extending between the first optical element and the second optical element, wherein the intermediary optical path is coincident with the pivot axis.

Variants of the optical transmission hinge according to the first aspect may further include one or more of the features described in A1 to A12 below.

A1: The first optical element includes a first facet, the second optical element includes a second facet, and the first and second facets are intersected by the pivot axis. The first facet and the second facet may be reflective surfaces. Alternatively, the first optical element may be a reflector or a prism, and the second optical element may be a reflector or a prism.

A2: A first optical path extends at least partially within the first hinge body and is coupled to the intermediary optical path by the first optical element.

A3: A second optical path extends at least partially within the second hinge body and is coupled to the intermediary optical path by the second optical element.

A4: The first hinge body includes a first end wall proximate the pivot joint, and the first end wall includes a first window. The second hinge body includes a second end wall proximate the pivot joint, and the second end wall includes a second window.

A5: The first hinge body has a zero angular offset from a reference axis when the first hinge body is not pivoted relative to the second hinge body about the pivot axis and a nonzero angular offset from the reference axis when the first hinge body is pivoted relative to the second hinge body about the pivot axis.

A6: The second optical path has a first section that extends from the second optical element to the first window (in A4) and a second section that extends from the second window (in A4) into the second hinge body. Optical communication between the first section and the second section is responsive to the angular offset of the first hinge body from the reference axis (in A5).

A7: The second window (in A4) is in a field of view of the first window (in A4) for each angular offset of the first hinge body from the reference axis (in A5) that is at or below an angular offset threshold, and the second window is out of a field of view of the first window for each angular offset of the first hinge body from the reference axis that exceeds the angular offset threshold.

A8: The first hinge body has a side wall formed contiguous with the first end wall (in A4), and the side wall is positioned to contact the second hinge body when the first hinge body is at a maximum angular offset from the reference axis (in A5).

A9: The first window (in A4) is formed in a first curved wall portion of the first end wall, and the second window (in A4) is formed in a second curved wall portion of the second end wall. The first curved wall portion and the second curved wall portion are concentric about the pivot axis. The first end wall and the second end wall may be separated by a gap.

A10: The first optical element includes a first facet oriented to receive light from the first optical path (in A2) and redirect light to the intermediary optical path, and the second optical element includes a second facet oriented to receive light from the intermediary optical path and redirect light to the second optical path (in A3).

A11: The pivot joint includes a first pivot pin and a second pivot pin, and the first and second pivot pins are axially aligned to define the pivot axis.

A12: The first hinge body and the second hinge body has first aligned holes and second aligned holes. The first pivot pin (in A11) is received in the first aligned holes, and the second pivot pin (in A11) is received in the second aligned holes.

In a second aspect of this disclosure, a temple may be summarized as including a first temple piece having a rear end forming a first hinge body; a second temple piece having a front end forming a second hinge body; a pivot joint formed between the first hinge body and the second hinge body, the pivot joint defining a pivot axis; a first optical element positioned on the pivot axis and coupled to the first hinge body; a second optical element positioned on the pivot axis and coupled to the second hinge body, the second optical element spaced apart from the first optical element; and an intermediary optical path extending between the first optical element and the second optical element, where the intermediary optical path is coincident with the pivot axis.

Variants of the temple according to the second aspect may further include one or more of the features described in B1 to B8 below.

B1: The first optical element is a reflector or a prism. The second optical element is a reflector or a prism.

B2: A first optical path extends at least partially within the first hinge body and is coupled to the intermediary optical path by the first optical element. A second optical path extends at least partially within the second hinge body and is coupled to the intermediary optical path by the second optical element.

B3: The first hinge body has a zero angular offset from a reference axis when the first hinge body is not pivoted relative to the second hinge body about the pivot axis and a nonzero angular offset from the reference axis when the first hinge body is pivoted relative to the second hinge body about the pivot axis.

B4: The first hinge body includes a first window. The second hinge body includes a second window. The second window is in a field of view of the first window for each angular offset of the first hinge body from the reference axis (in B3) that is at or below an angular offset threshold. The second window is out of the field of view of the first window for each angular offset of the first hinge body from the reference axis that exceeds the angular offset threshold.

B5: The first window (in B4) is formed in a first end wall of the first hinge body that is proximate the pivot joint. The second window (in B4) is formed in a second end wall of the second hinge body that is proximate the pivot joint.

B6: The first hinge body has a side wall formed contiguous with the first end wall (in B5). The side wall contacts the second hinge body when the first hinge body is at a maximum angular offset from the reference axis (in B4).

B7: The first window (in B4, B5) is formed in a first curved wall portion of the first end wall (in B5). The second window (in B4, B5) is formed in a second curved wall portion of the second wall. The first curved wall portion and the second curved wall portion are concentric about the pivot axis.

B8: The first optical element includes a first facet oriented to receive light from the first optical path and redirect light to the intermediary optical path. The second optical element includes a second facet oriented to receive light from the intermediary optical path and redirect light to the second optical path.

In a third aspect of this disclosure, a temple may be summarized as including a first temple piece, a second temple piece, and an optical transmission hinge according to the first aspect (or a variation thereof), where a rear end of the first temple piece forms the first hinge body of the optical transmission and a front end of the second temple piece forms the second hinge body of the optical transmission hinge.

In a fourth aspect of this disclosure, a WHUD may be summarized as including a frame front carrying at least one lens; at least one temple coupled to a side of the frame front, the at least one temple comprising a first temple piece having a rear end and a second temple piece having a front end; and an optical transmission hinge formed between the rear end of the first temple piece and the front end of the second temple piece. The optical transmission hinge includes a first hinge body formed integrally with the rear end of the first temple piece; a second hinge body formed integrally with the front end of the second temple piece; a pivot joint formed between the first hinge body and the second hinge body, the pivot joint defining a pivot axis; a first optical element positioned on the pivot axis and coupled to the first hinge body; a second optical element positioned on the pivot axis and coupled to the second hinge body, the second optical element spaced apart from the first optical element; and an intermediary optical path extending between the first optical element and the second optical element, wherein the intermediary optical path is coincident with the pivot axis.

In a fifth aspect of this disclosure, a WHUD may be summarized as including a frame front carrying at least one lens; at least one temple coupled to a side of the frame front, the at least one temple comprising a first temple piece having a rear end and a second temple piece having a front end; and an optical transmission hinge according to the first aspect (or a variation thereof) formed between the rear end of the first temple piece and the front end of the second temple piece. In some cases, the first temple piece carries an optical scanner, the second temple piece carries a light engine, and light is transmitted from the light engine to the optical scanner through the optical transmission hinge. In some cases, the at least one lens carries an optical combiner including a lightguide, an in-coupler positioned to couple light into the lightguide, and an out-coupler positioned to couple light out of the lightguide. In some cases, the optical scanner is positioned in the first temple piece to directly scan light over the in-coupler. In some cases, a second temple is coupled to a second side of the frame front by a front hinge. In some cases, the location of front hinge relative to a bridge center of the frame front is different from a location of optical transmission hinge relative to the bridge center, resulting in an asymmetric folded configuration of the WHUD.

The foregoing general description and the following detailed description are exemplary of the invention and are intended to provide an overview or framework for understanding the nature of the invention as it is claimed. The accompanying drawings are included to provide further understanding of the invention and are incorporated in and constitute part of this specification. The drawings illustrate various embodiments of the invention and together with the description serve to explain the principles and operation of the invention.

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 is a perspective view of an optical transmission hinge in an open position.

FIG. 2 is a perspective view of the optical transmission hinge of FIG. 1 in the closed position.

FIG. 3 is a schematic view of a pivot joint that may be used in the optical transmission hinge of FIGS. 1 and 2.

FIG. 4 is a schematic view of another pivot joint that may be used in the optical transmission hinge of FIGS. 1 and 2.

FIG. 5 is a vertical cross-sectional view of the optical transmission hinge of FIG. 1.

FIG. 6 is a horizontal cross-sectional view of the optical transmission hinge of FIGS. 1 and 2, showing the hinge in a fully open position.

FIG. 7 is a horizontal cross-sectional view of the optical transmission hinge of FIGS. 1 and 2, showing the hinge in a fully closed position.

FIG. 8 is a horizontal cross-sectional view of the optical transmission hinge of FIGS. 1 and 2, showing the hinge in an intermediate position between the fully open position and the fully closed position.

FIG. 9 is a top plan view of a temple including the optical transmission hinge of FIGS. 1 and 2 in an extended configuration.

FIG. 10 is a top plan view of a temple including the optical transmission hinge of FIGS. 1 and 2 in a folded configuration.

FIG. 11 is a top plan view of a WHUD incorporating the temple of FIGS. 9 and 10 in a folded configuration.

FIG. 12 is a top plan view of a WHUD incorporating the temple of FIGS. 9 and 10 in an extended configuration.

FIG. 13 is a top plan view of an extended configuration of a WHUD including hinges at different positions relative to a frame front.

FIG. 14 shows a folded configuration of the WHUD of FIG. 13.

FIG. 15 is a schematic of a portion of a WHUD showing light transmitted from a light engine to an optical scanner through an optical transmission hinge.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices have not been shown or described in detail to avoid unnecessarily obscuring descriptions of the embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

In this disclosure, unless the context requires otherwise, throughout the specification and claims which follow, the word “comprise” and variations thereof, such as, “comprises” and “comprising” are to be construed in an open, inclusive sense, that is as “including, but not limited to.”

In this disclosure, reference to “one implementation” or “an implementation” or to “one embodiment” or “an embodiment” means that a particular feature, structures, or characteristics may be combined in any suitable manner in one or more implementations or one or more embodiments.

In this disclosure, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the disclosure provided herein are for convenience only and do not interpret the scope or meaning of the embodiments or implementations.

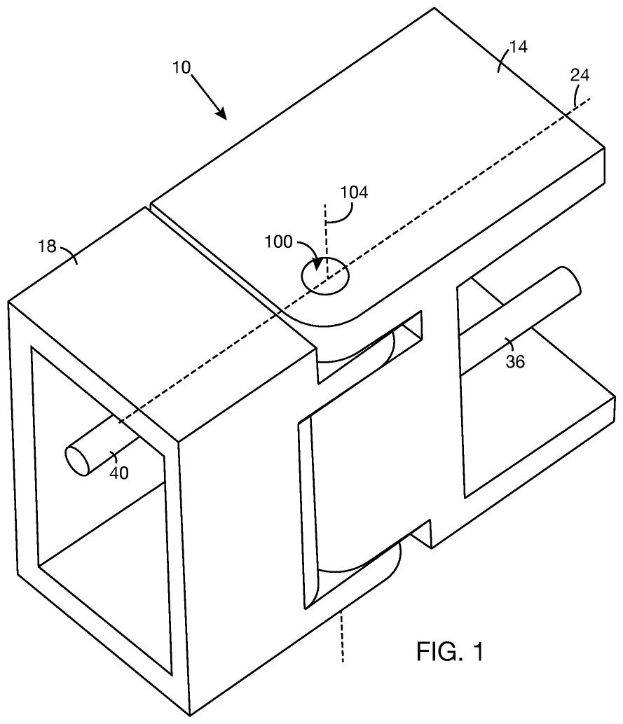

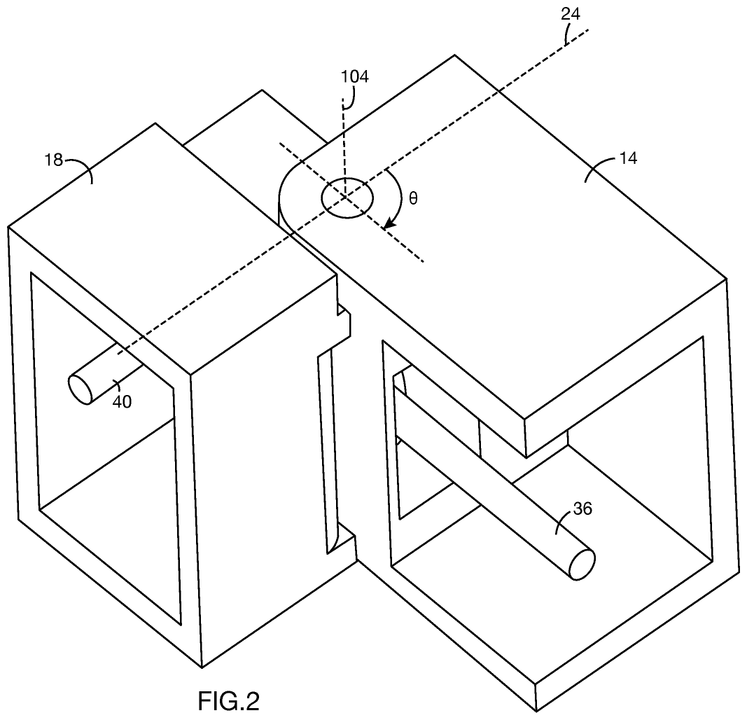

FIG. 1 shows an optical transmission hinge 10 including a first hinge body 14, a second hinge body 18, and a pivot joint 100 coupling the first hinge body 14 to the second hinge body 18. Pivot joint 100 defines a pivot axis 104 about which each of first hinge body 14 and second hinge body 18 may rotate. Typically, one hinge body, e.g., second hinge body 18, will be held fixed while the other hinge body, e.g., first hinge body 14, rotates. For discussion purposes, a reference axis 24 that is transverse to pivot axis 104 and that is always aligned with second hinge body 18, as shown in FIG. 1, may be defined. When first hinge body 14 is not pivoted relative to second hinge body 18, as shown in FIG. 1, the angular offset of first hinge body 14 from reference axis 24 is zero. When first hinge body 14 is pivoted relative to second hinge body 18, as shown for example in FIG. 2, the angular offset, θ, of first hinge body 14 from reference axis 24 is nonzero. Pivot joint 100 allows optical transmission hinge 10 to move between a fully open position, as shown in FIG. 1, and a fully closed position, as shown in FIG. 2.

Pivot joint 100 includes optical elements and an optical path between the optical elements (not visible in FIGS. 1 and 2) that enable light from a first optical path 36 in first hinge body 14 to be transmitted to a second optical path 40 in the second hinge body 18. In one example, coupling of light from first hinge body 14 to second hinge body 18 through pivot joint 100 is permitted only when the angular offset of the first hinge body 14 from reference axis 24 does not exceed an angular offset threshold, θₜ. Thus, for example, light is coupled between first hinge body 14 and second hinge body 18 if the angular offset of the first hinge body 14 from the reference axis 24 is in a range from 0 to θₜ, and light is not coupled between the first hinge body 14 and the second hinge body 18 if the angular offset of the first hinge body 14 from reference axis 24 is in a range from >θₜ to θₘ, where θₜ is the angular offset threshold and θₘ is the maximum allowable angular offset. θₜ and θₘ are design elements. As a non-limiting example, e.g., when optical transmission hinge 10 is employed in a temple of a WHUD, θₜ may be in a range from 2° to 5°, and θₘ may be in a range from 90° to 110°.

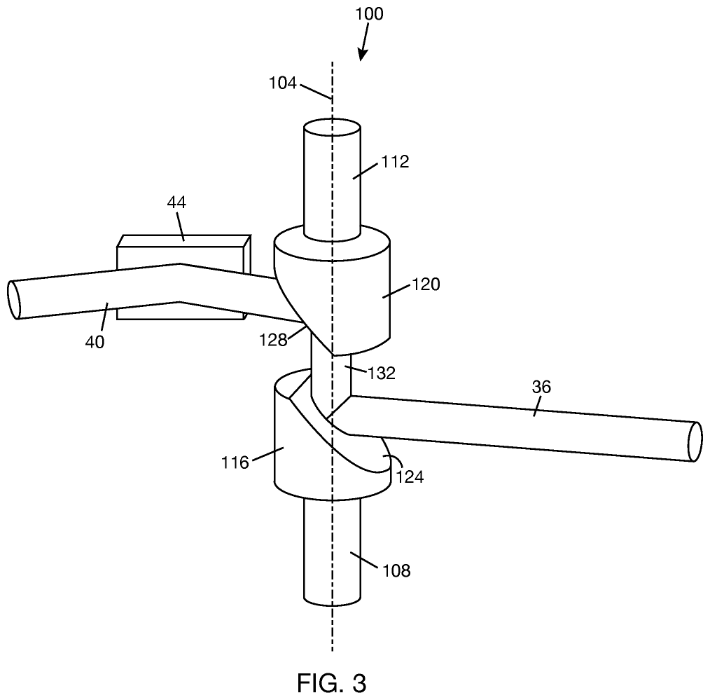

FIG. 3 shows pivot joint 100 according to one implementation. Pivot joint 100 includes pivot pins 108, 112 which are spaced apart and axially aligned to define pivot axis 104. A first optical element 116 and a second optical element 120 are arranged between pivot pins 108, 112. Optical elements 116, 120 are spaced apart along pivot axis 104 and are intersected by pivot axis 104. First optical element 116 may be proximate first pivot pin 108, and second optical element 120 may be proximate second pivot pin 112. An intermediary optical path 132 is defined between first optical element 116 and second optical element 120 along pivot axis 104. Light enters intermediary optical path 132 through first optical element 116, and light exits intermediary optical path 132 through second optical element 120. When pivot joint 100 is used to couple two hinge bodies together, e.g., hinge bodies 14, 18 in FIGS. 1 and 2, first optical element 116 will be coupled to one of the hinge bodies, e.g., first hinge body 14, and second optical element 120 will be coupled to the other of the hinge bodies, e.g., second hinge body 18. Thus, relative motion between the hinge bodies about pivot axis 104 will result in relative motion between the optical elements 116, 120 about pivot axis 104. For all rotational positions of optical elements 116, 120 about pivot axis 104, intermediary optical path 132 is coincident with pivot axis 104.

First optical element 116 is positioned and oriented to couple light from first optical path 36 (see, also, FIGS. 1 and 2) into intermediary optical path 132, and second optical element 120 is positioned and oriented to couple light from intermediary optical path 132 to second optical path 40 (see, also, FIGS. 1 and 2). In one example, first optical element 116 has a facet 124, and second optical element 120 has a facet 128. Facets 124, 128 are intersected by pivot axis 104 and are in opposing relation. Intermediary optical path 132 is defined between facets 124, 128. Facet 124 is positioned and oriented to receive light from first optical path 36 and redirect the light into intermediary optical path 132. Facet 128 is positioned and oriented to receive light from intermediary optical path 32 and redirect the light to second optical path 40. FIG. 3 shows that a beam directing element 44, such as a mirror, may redirect the light received in second optical path 40. In general, each of first and second optical paths 36, 40 may include any desirable optical elements to redirect light in first optical path 36 and/or second optical path 40 or for other purposes, such as rotation of the beam.

In one example, optical elements 116, 120 are reflectors. In one example, optical elements 116, 120 may be cylindrical bodies cut with an inclined plane to form facets 124, 128, respectively. Each optical element 116, 120 will have the axial axis of the corresponding cylindrical body. At least a portion of optical elements 116, 120 including facets 124, 128 may be made from a reflective material, or a reflective coating may be applied to facets 124, 128. The position and orientation of optical element 116 in pivot joint 100 may be such that the axial axis of the optical element 116 is aligned with pivot axis 104 and that facet 124 is inclined relative to pivot axis 104. Similarly, the position and orientation of optical element 120 in pivot joint 100 may be such that the axial axis of the optical element 120 is aligned with pivot axis 104 and that facet 128 is inclined relative to pivot axis 104. As a non-limiting example, each of facets 124, 128 may be inclined at 45° relative to pivot axis 104.

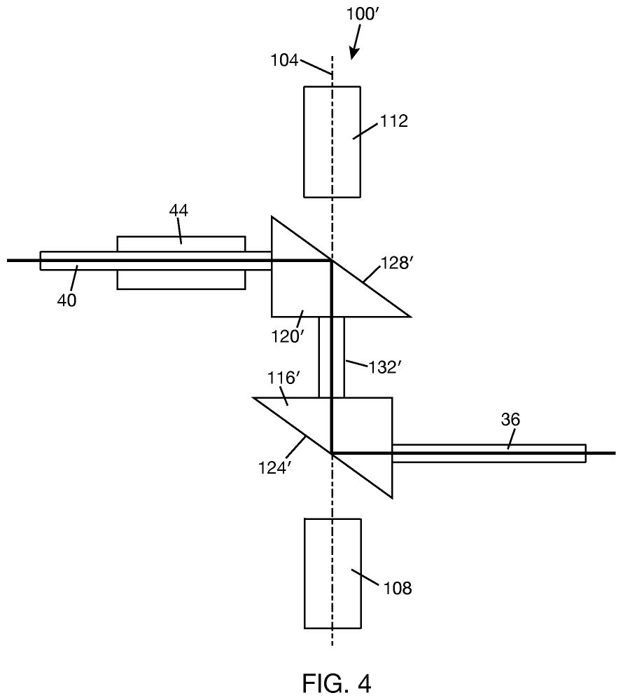

FIG. 4 shows another example of a pivot joint 100′ where first optical element 116′ and second optical element 120′ are prisms. For continuity, the same reference numbers have been retained in FIG. 4 for parts of FIG. 4 that are common with FIG. 3. In FIG. 4, optical elements 116′, 120′ have facets 124′, 128′, respectively, which are intersected by pivot axis 104. Facets 124′, 128′ are also inclined relative to pivot axis 104. An intermediary optical path 132′ is defined between optical elements 116′, 120′, or between facets 124′, 128′, along pivot axis 104. As in the example of FIG. 3, intermediary optical path 132′ is coincident with pivot axis 104 for all rotational positions of optical elements 116′, 120′ about pivot axis 104. Light from first optical path 36 enters optical element 116a and is redirected by facet 124′ to intermediary optical path 132′. Light from intermediary optical path 132′ enters optical element 120′ and is redirected by facet 128′ to second optical path 40.

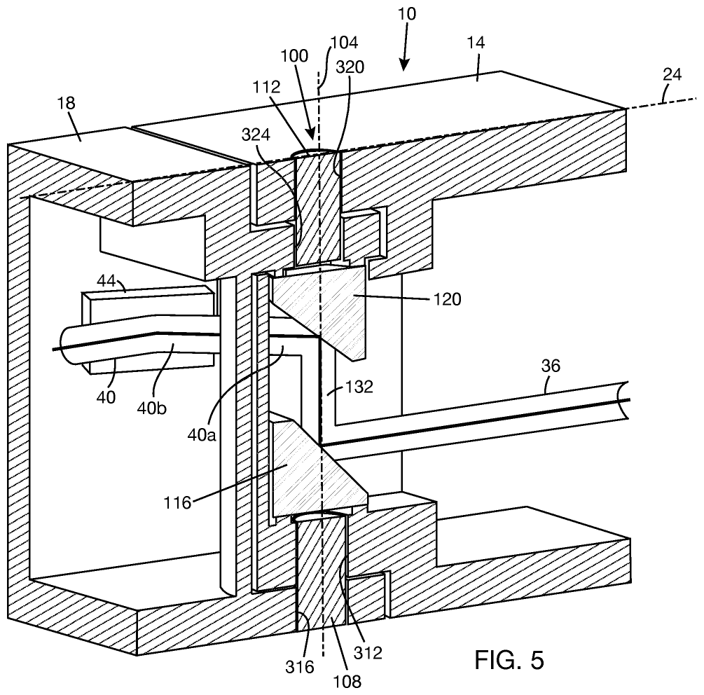

FIG. 5 shows pivot joint 100 between hinge bodies 14, 18 (pivot joint 100′ in FIG. 4 may be substituted for pivot joint 100 in this example). First hinge body 14 has a first hole 312. Second hinge body 18 has a first hole 316 proximate first hole 312 of first hinge body 14. Holes 312, 316 are axially aligned with pivot axis 104 and receive pivot pin 108. Pivot pin 108 may be retained in place using any suitable method that allows either of first hinge body 14 and second hinge body 18 to rotate about pivot axis 104. For example, pivot pin 108 may be secured to one of, but not both of, holes 312, 316 using adhesive, by press-fitting, or the like. First hinge body 14 has a second hole 320. Second hinge body 18 has a second hole 324 proximate second hole 320 of first hinge body 14. Holes 320, 324 are axially aligned with pivot axis 104 and receive pivot pin 112. Pivot pin 112 may be retained in place using any suitable method that allows first hinge body 14 to rotate relative to second hinge body 18. For example, pivot pin 112 may be secured to one of, but not both of, holes 320, 324 using adhesive, by press-fitting, or the like. First optical element 116 is coupled to first hinge body 14, and second optical element 120 is coupled to second hinge body 18.

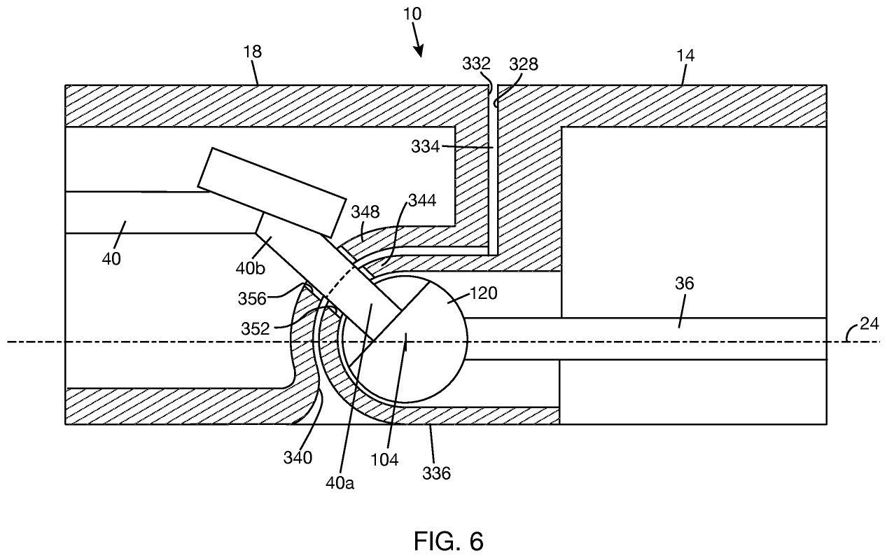

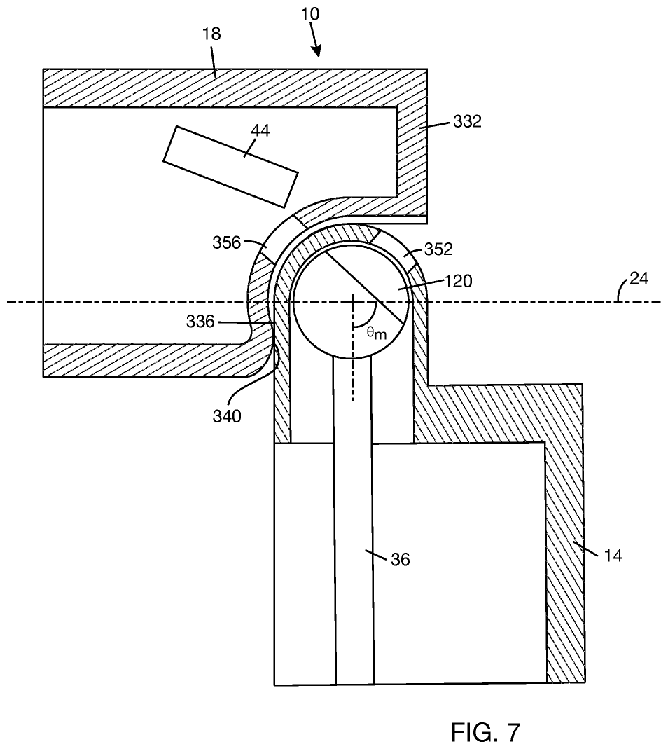

Referring to FIG. 6, first hinge body 14 has an end wall 328, and second hinge body 18 has an end wall 332. End walls 328, 332 are in opposing relation when optical transmission hinge 10 is in the fully open position, as shown in FIG. 6. In some examples, end walls 328, 332 may be separated by a gap 334. The gap size may be in a range from 0.1 mm to 0.5 mm. In one example, first hinge body 14 has a side wall 336 that is contiguous with end wall 328. First hinge body 14 is allowed to rotate about pivot axis 104, from the fully open position, until side wall 336 abuts second hinge body 18. For example, as shown in FIG. 7, side wall 336 of first hinge body 14 may abut a stop surface 340 on end wall 332 of second hinge body 18. First hinge body 14 is at a maximum angular offset, θₘ, from reference axis 24 when side wall 336 abuts second hinge body 18.

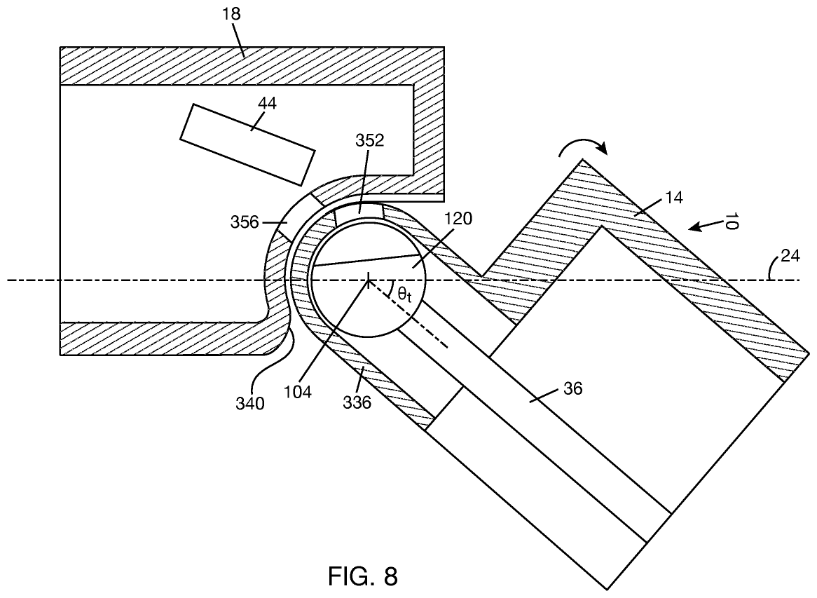

Returning to FIG. 6, end wall 328 may include a curved wall section 344, and end wall 332 may include a curved wall section 348. In one implementation, curved wall sections 344, 348 are concentric about pivot axis 104. This will allow curved wall section 344 to glide along curved wall section 348, with or without gap 334 between curved wall sections 344, 348, as first hinge body 14 is pivoted relative to second hinge body 18. A first window 352 is formed in curved wall section 344, and a corresponding second window 356 is formed in curved wall section 348. In the fully open position, second window 356 is in a field of view of first window 352. As first hinge body 14 moves away from the fully open position by rotation about pivot axis 104, second window 356 will start to move away from the field of view of first window 352. As shown in FIG. 8, as soon as the angular offset of first hinge body 14 exceeds an angular offset threshold, θₜ, second window 356 will be completely out of the field of view of first window 352.

Referring to FIG. 6, second optical path 40 is open when second window 356 is in a field of view of window 352 and closed otherwise. For example, second optical path 40 may be considered as having a first section 40a that extends from optical element 120 to first window 352 and a second section 40b that extends from second window 356 to inside of second hinge body 18. When window 356 is in the field of view of window 352, light can be transmitted from first section 40a to second section 40b, meaning that second optical path 40 is open. When window 356 is out of the field of view of window 352, light cannot be transmitted from first section 40a to second section 40b, meaning that second optical path 40 is closed. As shown in FIG. 5, first optical path 36 extends from inside first hinge body 14 to first optical element 116, and intermediary optical path 132 extends from first optical element 116 to second optical element 120. When second optical path 40 is open, light can be coupled from first optical path 36 to second optical path 40 through optical elements 116, 120 and intermediary optical path 132 in pivot joint 100.

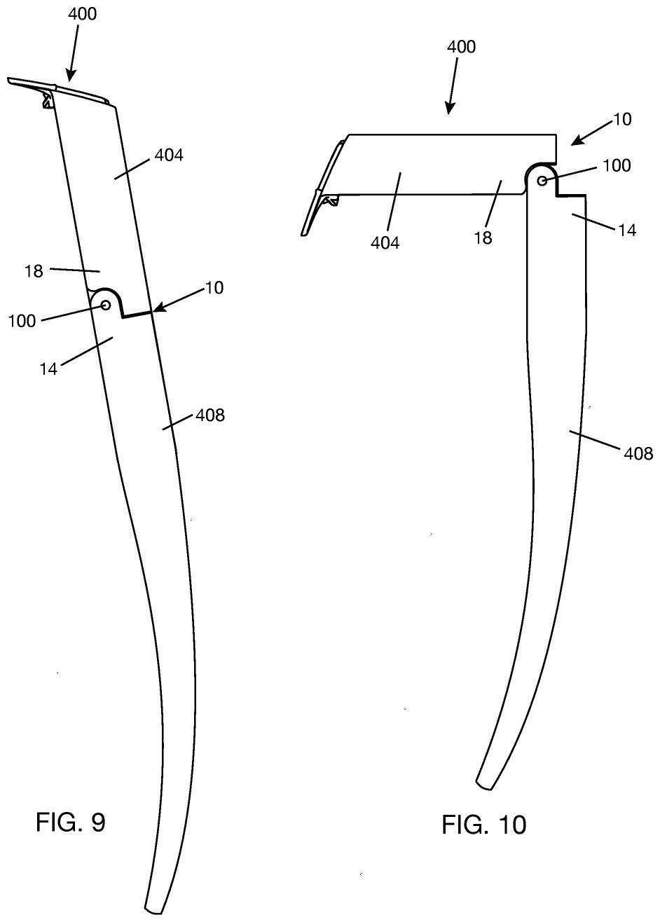

Optical transmission hinge 10 may be used in construction of a WHUD having the appearance of eyeglasses. Optical transmission hinge 10 may be located on a temple carrying components that project light to form a display in a display space in a field of view of the WHUD. FIGS. 9 and 10 show an example of a temple 400 including optical transmission hinge 10. In FIG. 9, temple 400 is in the fully open (or unfolded) position. In FIG. 10, temple 400 is in the fully closed (or folded) position. Temple 400 includes front temple piece 404 and rear temple piece 408. The front temple piece 404 is the part of temple 400 that will be attached to a frame front of the wearable heads-up display. Hinge body 18 of optical transmission hinge 10 is formed integrally with a rear end of front temple piece 404. Hinge body 14 of optical transmission hinge 10 is formed integrally with a front end of rear temple piece 408. Hinge bodies 14, 18 are coupled together by pivot joint 100 (or pivot joint 100′ in FIG. 4) as described above. In some cases, each of the front temple piece 404 and rear temple piece 408 has a cavity for holding a portion of the display components of the WHUD. Optical transmission hinge 10 will couple light from the rear temple piece 408 to the front temple piece 404 during use of the wearable heads-up display.

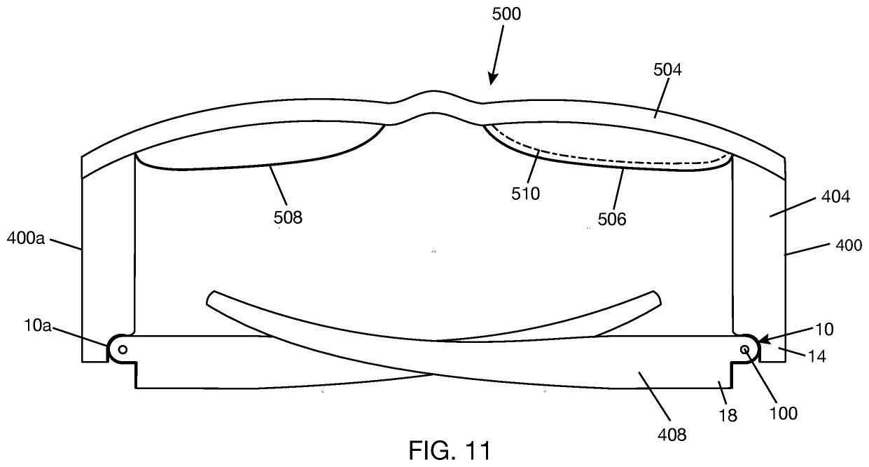

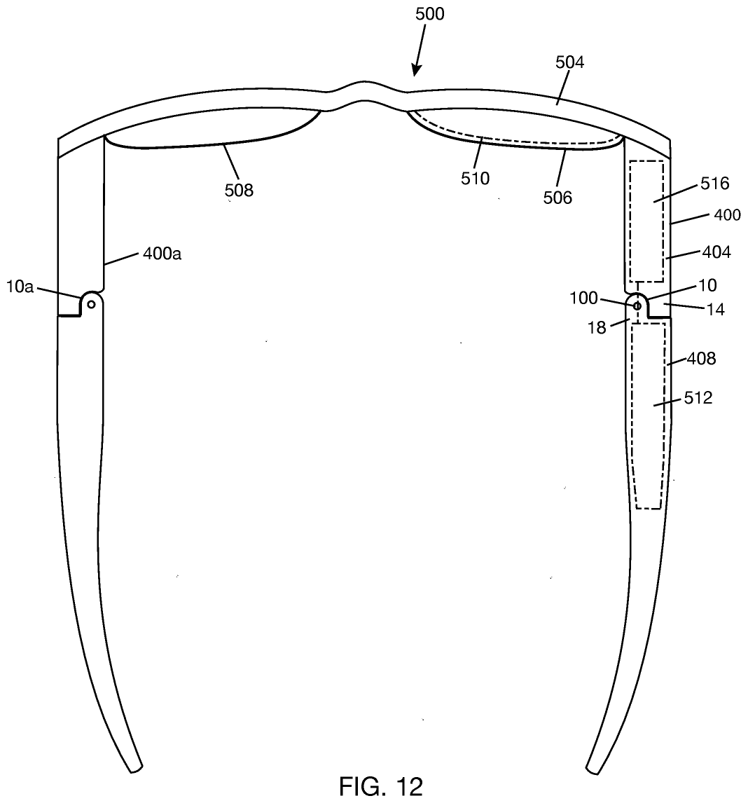

FIG. 11 shows a WHUD 500 having a support structure including a frame front 504 and temples 400, 400a attached to opposite sides of frame front 504. FIG. 11 shows WHUD 500 in the folded configuration, where temples 400, 400a are folded at their respective hinges 10, 10a. Temples 400, 400a can be extended to their use positions via their respective hinges 10, 10a. FIG. 12 shows WHUD 500 in the extended configuration. Temples 400, 400a extend over the ears of the user when WHUD 500 is worn on the head of the user. Temple 400 includes the optical transmission hinge 10, as described above. Temple 400a may have the same structure as temple 400 but contain different components compared to temple 400. If it is not desired to transmit light within temple 400a, optical elements that transmit light may be omitted from hinge 10a. Frame front 504 carries lenses 506, 508. Lens 506 may include an optical combiner 510, such as a holographic optical element, a lightguide, or a waveguide. Although not shown, lens 508 may also include an optical combiner as described above. In general, either or both of lenses 506, 508 may include an optical combiner.

Front temple piece 404 is attached to frame front 504 and does not move relative to frame front 504. In some cases, front temple piece 404 may be formed integrally with frame front 504. Rear temple piece 408 can move relative to front temple piece 404 about pivot joint 100. When WHUD 500 is worn on the head of the user, rear temple piece 408 is generally aligned with front temple piece 404. However, there may be slight movements of rear temple piece 408 about the pivot joint 100 as the head moves about or when the user adjusts the position of WHUD 500 on the head. If the movement is within the range that indicates that WHUD 500 is in use (e.g., corresponding to angular offsets of first hinge body 14 not exceeding an angular offset threshold), light will be coupled from the rear temple piece 408 to the front temple piece 404. Where the second optical element (120 in FIGS. 3 and 5) is attached to second hinge body 18 and second hinge body 18 is formed integrally with front temple piece 404, light will be coupled from the second optical element (120 in FIG. 3, 120′ in FIG. 4) into front temple piece 404 in the same manner for all movements of the rear temple piece 408 about pivot joint 100 within the use range of the WHUD. However, the beam may be rotated at the second optical element. The rotational error will be related to the amount of rotation of the rear temple piece 408 about the pivot joint 100. If the beam is not circularized, it may be necessary to compensate for rotation of the beam.

In one implementation, temple 400 contains at least some display components of WHUD 500. In one example, a first group of display components 512 (in FIG. 12), e.g., illumination source and related electronics, is disposed in the rear temple piece 408, and a second group of display components 516 (in FIG. 12), e.g., imaging optics and related control electronics, is disposed in the front temple piece 404. Illumination source may include, for example, red, green, and blue laser diodes to generate visible light and, optionally, infrared laser diode to generate infrared light. Imaging optics may include, for example, scan mirror(s) to scan the light and various relay optics to direct the light to the optical combiner 510 carried by lens 506. The examples of the first and second groups of display components 512, 516 given above are not intended to be limiting. The length of the front temple piece 408 need only be long enough to accommodate the first group of display components 512. Thus, it may be possible to have a front temple piece 408 with a length that positions the optical transmission hinge 10 close to the frame front, which would allow the compact form of the WHUD 500 to more closely resemble that of conventional eyewear with front hinges.

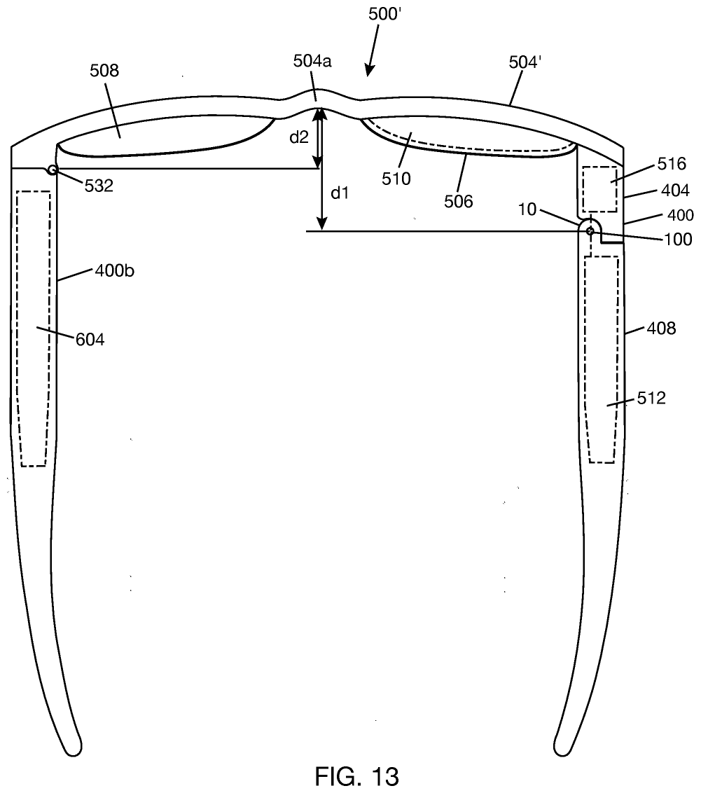

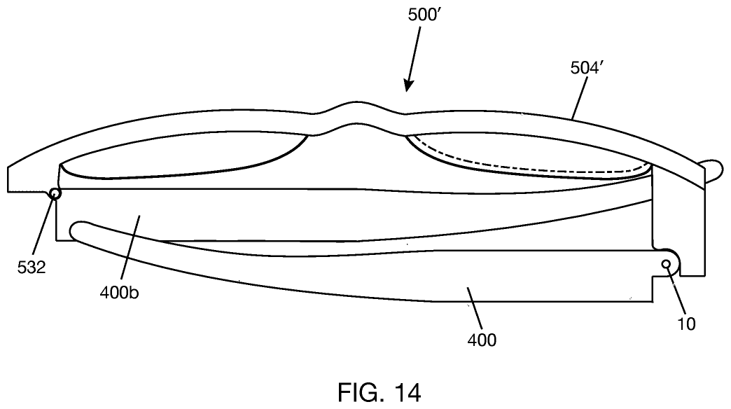

FIGS. 13 and 14 show another example WHUD 500′ where a temple 400b is attached to frame front 504′ by a front hinge 532. WHUD 500′ is shown in the extended configuration in FIG. 13 and in the folded configuration in FIG. 14. In one implementation, front hinge 532 is not an optical transmission hinge (e.g., does not carry optical elements). In this case, temple 400b carries components that do not need to communicate optically across front hinge 532. For example, temple 400b may carry a power source 536 that provides electrical power to various components of WHUD 500′. Temple 400 with optical transmission hinge 10 is attached to the other side of frame front 504′. In FIG. 13, the offset d1 of hinge 10 relative to a bridge center 504a of frame front 504 is different from the offset d2 of hinge 532 relative to the bridge center 504a of frame front 504′. In particular, hinge 10 is set back further relative to bridge center 504a compared to front hinge 532. This generally results in asymmetric folding of the temples of WHUD 500′, as shown in FIG. 14, where temple 400b is folded closer to frame front 504′ compared to temple 400.

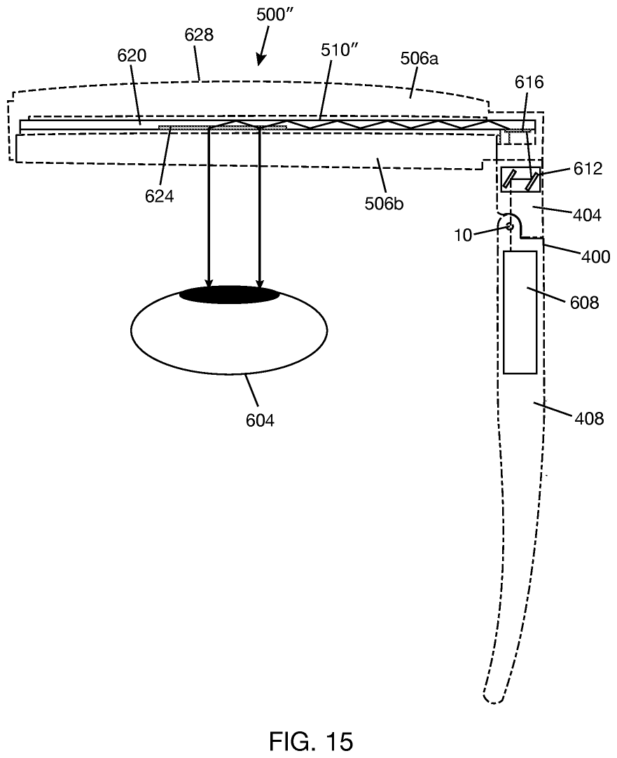

FIG. 15 shows a portion of WHUD 500″ positioned relative to an eye 604. The portion of the WHUD 500″ shown includes a light engine 608 to generate light and an optical scanner 612 to scan the light over a target. The portion of WHUD 500″ shown also includes an optical combiner 510″, which is positioned in a field of view of eye 604. In one example, optical combiner 510″ includes an in-coupler 616, a lightguide (or waveguide) 620, and an out-coupler 624. In-coupler 616 is positioned and designed to receive light from optical scanner 612 and couple the received light into lightguide 620. The light coupled into lightguide 620 propagates along lightguide 620 by total internal reflection. Out-coupler 624 is positioned and designed to couple light out of lightguide 620. At least a portion of the light coupled out of lightguide 620 through out-coupler 624 will be received by eye 604. Lightguide 620 may be stacked with lenses 506a, 506b. The curvatures of the lens surfaces of either or both of lenses 506a, 506b may be selected to achieve a desired eyeglasses prescription and/or other combiner lens function, such as displaying an image at a particular distance in front of the world side 628 of the lens stack.

Optical scanner 612 and light engine 608, as well as other display components not specifically shown, are carried by temple 400. In the illustrated example, optical scanner 612 is positioned within front temple piece 404, and light engine 608 is positioned within rear temple piece 408. Thus, optical scanner 612 and light engine 608 communicate optically through optical transmission hinge 10. Light received by optical scanner 612 is scanned over in-coupler 616. In some cases, optical scanner 612 may be positioned to directly scan light over in-coupler 616 (i.e., there are no relay optics between optical scanner 612 and in-coupler 616). For example, optical scanner 612 may be raster scan mirror(s) or Lissajous scan mirror(s). Lissajous scan mirror(s) may have the advantage of being able to be made into a very small size compared to raster scan mirror(s), which will facilitate positioning of the scan mirror(s) very close to in-coupler 624. Scan mirror(s) of optical scanner 612 may be microelectromechanical systems (MEMS) mirror(s), piezoelectric mirror(s), or the like. Light engine 608 includes light sources (not shown separately), such as laser diodes, infrared vertical cavity surface emitting laser (VCSEL), light emitting diode (LED), micro-LED, or the like, to generate light. Light engine 608 may include other optics to combine multiple light beams and to direct the combined light beam to the optical element (116 in FIG. 3) at the input end of optical transmission hinge 10.

The above description of illustrated embodiments and implementations, including what is described in the Abstract of the disclosure, is not intended to be exhaustive or to limit the embodiments and implementations to the precise forms disclosed. Although specific embodiments, implementations, and examples are described herein for illustrative purposes, various equivalent modifications can be made, as will be recognized by those skilled in the relevant art. Accordingly, the scope of the invention should be limited only by the attached claims. The teachings provided herein can be applied to other structures requiring optical transmission hinges and are not necessarily limited to wearable heads-up displays.

1. An optical transmission hinge, comprising:
a first hinge body;
a second hinge body;
a pivot joint formed between the first hinge body and the second hinge body, the pivot joint defining a pivot axis;
a first optical element positioned on the pivot axis and coupled to the first hinge body;
a second optical element positioned on the pivot axis and coupled to the second hinge body, the second optical element spaced apart from the first optical element; and
an intermediary optical path extending between the first optical element and the second optical element, wherein the intermediary optical path is coincident with the pivot axis.

2. The optical transmission hinge of claim 1, wherein the first optical element includes a first facet, wherein the second optical element includes a second facet, wherein the first facet and the second facet are intersected by the pivot axis, and wherein the first and second facets are reflective surfaces.

3. The optical transmission hinge of claim 1, wherein the first optical element includes a first facet, wherein the second optical element includes a second facet, wherein the first facet and the second facet are intersected by the pivot axis, and wherein each of the first optical element and the second optical element is a reflector or a prism.

4. The optical transmission hinge of claim 1, further comprising:
a first optical path extending at least partially within the first hinge body, the first optical path coupled to the intermediary optical path by the first optical element; and
a second optical path extending at least partially within the second hinge body, the second optical path coupled to the intermediary optical path by the second optical element.

5. The optical transmission hinge of claim 4, wherein the first hinge body includes a first end wall proximate the pivot joint, the first end wall having a first window, and wherein the second hinge body includes a second end wall proximate the pivot joint, the second end wall having a second window.

6. The optical transmission hinge of claim 5, wherein the first hinge body has a zero angular offset from a reference axis when the first hinge body is not pivoted relative to the second hinge body about the pivot axis and a nonzero angular offset from the reference axis when the first hinge body is pivoted relative to the second hinge body about the pivot axis.

7. The optical transmission hinge of claim 6, wherein the second optical path has a first section that extends from the second optical element to the first window and a second section that extends from the second window into the second hinge body, and wherein optical communication between the first section and the second section is responsive to the angular offset of the first hinge body from the reference axis.

8. The optical transmission hinge of claim 7, wherein the second window is in a field of view of the first window for each angular offset of the first hinge body from the reference axis that is at or below an angular offset threshold, and wherein the second window is out of the field of view of the first window for each angular offset of the first hinge body from the reference axis that exceeds the angular offset threshold.

9. The optical transmission hinge of claim 6, wherein the first hinge body has a side wall formed contiguous with the first end wall, and wherein the side wall is positioned to contact the second hinge body when the first hinge body is at a maximum angular offset from the reference axis.

10. The optical transmission hinge of claim 5, wherein the first window is formed in a first curved wall portion of the first end wall, wherein the second window is formed in a second curved wall portion of the second end wall, and wherein the first curved wall portion and the second curved wall portion are concentric about the pivot axis.

11. The optical transmission hinge of claim 4, wherein the first optical element includes a first facet oriented to receive light from the first optical path and redirect light to the intermediary optical path, and wherein the second optical element includes a second facet oriented to receive light from the intermediary optical path and redirect light to the second optical path.

12. The optical transmission hinge of claim 1, wherein the pivot joint comprises a first pivot pin and a second pivot pin, and wherein the first and second pivot pins are axially aligned to define the pivot axis.

13. The optical transmission hinge of claim 12, wherein the first hinge body and the second hinge body have first aligned holes and second aligned holes, wherein the first pivot pin is received in the first aligned holes, and wherein the second pivot pin is received in the second aligned holes.

14. A wearable heads-up display, comprising:
a frame front carrying at least one lens; and
at least one temple coupled to a side of the frame front, the at least one temple comprising a first temple piece having a rear end and a second temple piece having a front end, the rear end of the first temple piece forming a first hinge body, the front end of the second temple piece forming a second hinge body;
a pivot joint formed between the first hinge body and the second hinge body, the pivot joint defining a pivot axis;
a first optical element positioned on the pivot axis and coupled to the first hinge body;
a second optical element positioned on the pivot axis and coupled to the second hinge body, the second optical element spaced apart from the first optical element; and
an intermediary optical path extending between the first optical element and the second optical element, wherein the intermediary optical path is coincident with the pivot axis.

15. The wearable heads-up display of claim 14, wherein the first optical element is a reflector or a prism, and wherein the second optical element is a reflector or a prism.

16. The wearable heads-up display of claim 14, further comprising:
a first optical path extending at least partially within the first hinge body, the first optical path coupled to the intermediary optical path by the first optical element; and
a second optical path extending at least partially within the second hinge body, the second optical path coupled to the intermediary optical path by the second optical element.

17. The wearable heads-up display of claim 16, wherein the first hinge body has a zero angular offset from a reference axis when the first hinge body is not pivoted relative to the second hinge body about the pivot axis and a nonzero angular offset from the reference axis when the first hinge body is pivoted relative to the second hinge body about the pivot axis, wherein the second optical path has a first section that extends from the second optical element to the first window and a second section that extends from the second window into the second hinge body, and wherein optical communication between the first section and the second section is responsive to the angular offset of the first hinge body from the reference axis.

18. The wearable heads-up display of claim 17, wherein the first hinge body includes a first end wall proximate the pivot joint and the second hinge body includes a second end wall proximate the pivot joint, wherein the first hinge body includes a first window formed in the first end wall and the second hinge body includes a second window formed in the second end wall, wherein the first window is in a field of view of the first window for each angular offset of the first hinge body from the reference axis that is at or below an angular offset threshold, and wherein the second window is out of a field of view of the first window for each angular offset of the first hinge body from the reference axis that exceeds the angular offset threshold.

19. The wearable heads-up display of claim 18, wherein the first hinge body has a side wall formed contiguous with the first end wall, and wherein the side wall is positioned to contact the second hinge body when the first hinge body is at a maximum angular offset from the reference axis.

20. The wearable heads-up display of claim 16, wherein the first optical element includes a first facet oriented to receive light from the first optical path and redirect light to the intermediary optical path, and wherein the second optical element includes a second facet oriented to receive light from the intermediary optical path and redirect light to the second optical path.
